(19) United States
(12) Patent Application Publication
(10) Pub. No.: US 2011/0122625 A1
(43) Pub. Date: May 26, 2011

(54) STORABLE HOLIDAY LIGHTS

(76) Inventors: Delores Ann Carone, Phoenix, AZ (US); Ivan Joseph Mlachak, Phoenix, AZ (US)

(21) Appl. No.: 12/623,401

(22) Filed: Nov. 21, 2009

(51) Int. Cl. F21S 4/00

(52) U.S. Cl. 362/249.14

(57) ABSTRACT

There is provided a festive/holiday lighting system capable of placing light strings in a stored configuration as well as a displayed configuration. The lighting system includes as elements a rotating rod, a series of light strings, a power cord, and a pair of end caps. The rotating rod defines a first end and a second end, as well as an interior region and an exterior region. The set of light strings is disposed so as extend from the rod in the display configuration and to coil around the exterior region of the rod in the stored configuration. The cord defines a plug end and a receiving end, and the cord is connected to and provides power to the light strings. Separate units of the lighting system can be electrically joined by connecting a plug end to a receiving end of the cord. A pair of end caps are connected to the first end and second end of the rod such that rod can rotate with respect to the end caps. Hangers can be attached to the end caps for suspending the light system from a structure such as a house. A user unrolls the rod so as to display the light strings when he or she wishes to display the lights, and the user then rolls the rod thereby wrapping the light strings around the rod (thus placing the light strings in the stored/concealed configuration) when he or she wishes to hide or store the lighting. In this manner the light system can be semi-permanently affixed to a house structure for multi-seasonal use. The lights are displayed when desired and concealed when not in use.

### FIELD OF THE INVENTION

The present invention relates to holiday or seasonal lighting. More particularly the present invention relates to a system and method of configuring lighting on a structure such as a house such that the lighting can be easily displayed when desired and then easily stored out of view when not in use.

### BACKGROUND OF THE INVENTION

A popular American custom is the display of festive holiday lighting. In the weeks before the Christmas holidays American homeowners spend considerable sums of money and go to extensive lengths to decorate their houses. String lighting in various colors is a very popular form of such holiday lighting. Another popular form of lighting is “icicle” lighting in which multiple strands of lights dangle vertically from a common connecting line. There exists an ongoing need for improved lighting systems that facilitate the placement and display of these kinds of holiday lighting.

In popular usage holiday lighting is typically hung on the exterior of a house or other structure. Oftentimes the lighting is configured so as to follow structural lines in a house such as the roof eaves. The string lighting is typically hung by hooks, nails, screws, staples and the like where the fasteners are driven into the housing structure itself. Icicle-type lighting is often suspended along a roof line, balcony perimeter, or patio perimeter. The typical custom is that a homeowner decorates his house before the holiday, he or she leaves the lights on permanent display during the holiday season, and then after the holiday has passed the lighting is removed and stored. One significant disadvantage of the present system of affixing holiday lighting is the time and work involved in hanging the lighting each year. Many homeowners would like to decorate their houses, but they are discouraged by the time and effort involved.

A certain social stigma is assigned to those homeowners who fail to remove their holiday lighting within a short time after the holiday has passed. With respect to the Christmas holiday, there is a general social expectation that holiday lights will be removed, at the latest, soon after the New Year. A homeowner who leaves his lighting on year round, on permanent display, is often thought of by others as lazy or déclassé. Thus some homeowners are further discouraged from displaying holiday lighting because, knowing the effort involved in removing the lighting, they do not want to commit to the effort that would be required. Thus, it would further be desired to provide an improved form of storable holiday lighting that allows a homeowner to quickly and easily store the lighting out of public view.

Some homeowners may leave the attaching means, the screws, hooks, nails, and the like, permanently affixed to the house. The attaching means may be unsightly, and it may generally be desired to remove them, but for some the effort to remove these attaching means is too much. Thus, it would be desired to provide a holiday lighting system in which an attaching or affixing means used to hold string lighting in place is generally hidden from view.

In addition to holiday lighting, some homeowners also like to use decorative lighting during other times and seasons of the year. For example during birthdays, weddings, graduations, anniversaries, and parties of all types, it is often desired to use festive lighting. A popular usage of such festive lighting (used outside the Christmas season) is to decorate a patio or backyard where the party goers will be aggregating. Barbeque surroundings are also an area that is typically decorated. Again, it is generally desired to use the festive lighting during the party or celebration and to remove the lighting once the party is concluded. However, because of the time and bother needed to first install and then remove the lighting, festive lighting is not used frequently. It would be desired to provide an improved lighting system that allows a user to quickly display and then hide lighting so that it can readily be used during parties.

With respect to holiday and festive lighting, there is a further long felt but unmet need for automated systems that decrease the amount of time required for daily observation and management of the lighting system. It would be desired to provide timers and controllers that roll up and unroll lighting at desired time intervals. Alternatively it would be desired to provide motorized rollers that can be actuated by remote control such as by wireless radio control, infrared control, or the like. Unfortunately the present state of the art does not satisfy this need with respect to decorative lighting.

Hence there has been identified a need to provide an improved method and means for displaying festive and holiday lighting. It would be desired to provide a method of affixing holiday lighting to a structure such as a residence such that the lighting can both be easily displayed and such that the holiday lighting can be easily hidden from view. It would also be desired that an improved holiday lighting system be configured such that it can be placed on new construction as well as easily retrofit to existing structures. It would further be desired to provide a method and means for a storable lighting system that is hardy and robust so as to withstand repeated usage cycles. The present invention addresses one or more of these needs.

### SUMMARY OF THE INVENTION

In accordance with one aspect of the present invention, and by way of example only, there is provided a lighting system having a display configuration and a stored configuration, and in which the lighting system includes: a rotating rod, a plurality of light strings attached to the rod wherein the light strings are coiled around the rod in the stored configuration; and wherein the light strings extend lengthwise from the rod in the display configuration. The lighting system further includes an electrical connection line connecting at least two individual light strings wherein the electrical connection is attached to the rod. The lighting system further includes a cover disposed around the rod.

In accordance with a further aspect of the present invention, and still by way of example only, there is provided a lighting system capable of placing light strings in a stored configuration as well as a displayed configuration. The lighting system includes as elements a rotating rod, a series of light strings, a power cord, and a pair of end caps. The rotating rod defines a first end and a second end, as well as an interior region and an exterior region. The set of light strings is disposed so as extend from the rod in the display configuration and to coil around the exterior region of the rod in the stored configuration. The cord defines a plug end and a receiving end, and the cord is connected to and provides power to the light strings. A pair of end caps are connected to the first end and second end of the rod such that rod can rotate with respect to the end caps. Hangers can be attached to the end caps for suspending the light system from a structure such as a house. A user unrolls the rod so as to display the light strings when he or she wishes to display the lights, and the user then rolls the rod thereby wrapping the light strings around the rod (thus placing the light strings in the stored/concealed configuration) when he or she wishes to hide or store the lighting. In this manner the light system can be semi-permanently affixed to a house structure for multi-seasonal use. The lights are displayed when desired and concealed when not in use. The central section of the cord may be substantially disposed within the interior region of the rod so that rotation of the rod does not foul the cord. End portions of the cord, such as the plug end and the receiving end, can extend through the first end and second end of the rod respectively.

The rod in the lighting system may be substantially cylindrical in shape to facilitate rotating of the rod as well as the wrapping and unwrapping of the light strings about the outer circumference of the rod. Further the rod may define a rotating bearing surface that fits with a cooperating receiving bearing surface positioned in the end cap. Additionally the end cap and the rod may define mutually contacting thrust bearing surfaces. The lighting system may further include a means for rotating the rod such as, but not limited to, gearing, electric motors, belt and pulley systems, manual turning, and ratchet systems.

Other independent features and advantages of the embodiments of the storable holiday lighting system will become apparent from the following detailed description, taken in conjunction with the accompanying drawings which illustrate, by way of example, the principles of the invention.

### BRIEF DESCRIPTION OF THE DRAWINGS

FIG. 1 is a perspective view of a storable holiday lighting system, in an exposed configuration, according to a first embodiment of the present invention;

FIG. 2 is a perspective view of a storable holiday lighting system, in a concealed configuration, according to a further embodiment of the present invention;

FIG. 3 is a further perspective view of a storable lighting system, according to a further embodiment of the present invention;

FIG. 4 is a close up cut away view of a storable lighting system with end cap feature, according to an embodiment of the present invention;

FIG. 5 is a view of an additional embodiment of the storable lighting system with end cap feature;

FIG. 6 is a view of an additional embodiment of the storable lighting system with end cap feature;

FIG. 7 is a view of an additional embodiment of the storable lighting system with end cap feature;

FIG. 8 is a cutaway side view of the storable lighting system displaying a rod disposed within a cover, according to an embodiment of the present invention; and

FIG. 9 is a cutaway side view of a structure with an embodiment of the storable lighting system affixed thereto, according to an embodiment of the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings. Wherever possible, common reference numbers are used throughout the multiple figures.

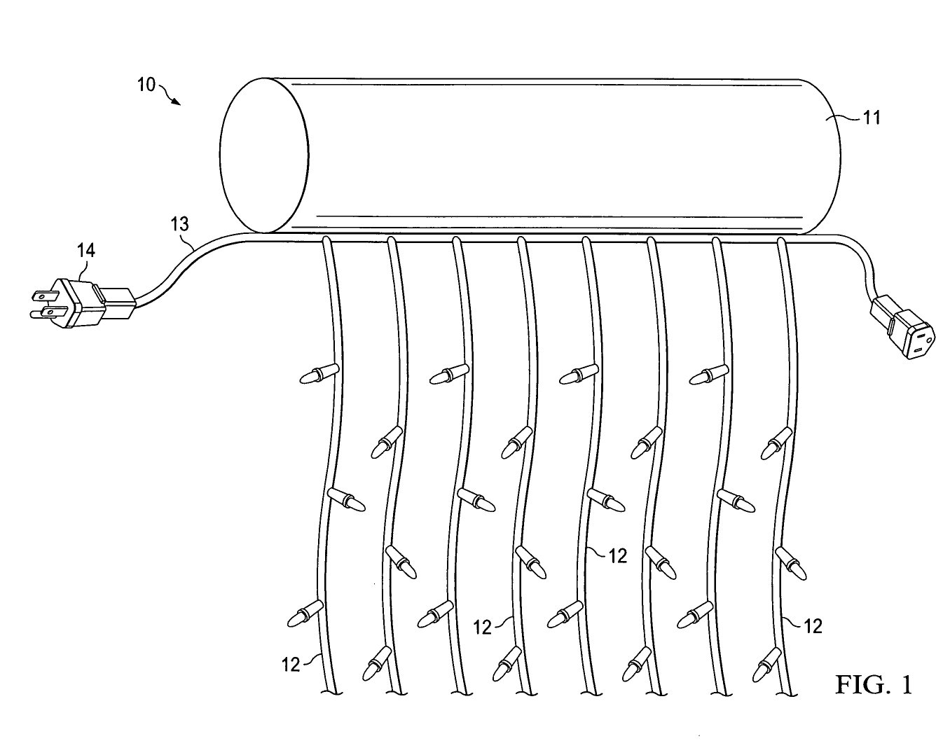

Referring now to FIG. 1 there is shown a first embodiment of the storable holiday lighting system 10 in an exposed position. System 10 includes rod 11 and light strings 12. Light strings 12 are configured so as to suspend from rod 11. FIG. 1 illustrates light strings 12 in a fully unrolled or exposed position such that they would be generally visible to an observer. As is known in the art, light strings 12 each comprise a strand with a display light disposed thereon. Typically, an individual light string 12 will include multiple such lights. The strand or string itself typically comprises the insulated conductor which provides electrical energy to the individual lights. Also, as is known in the art, electrical energy must be brought to each of the individual light strings 12 so as to energize the lights thereon. Typically a single continuous electric cord 13 will provide energy to a plurality of individual light strings 12 for a desired length. Consumer packages of icicle-type lighting often come in predetermined lengths such as 8, 10, or 12 feet or the like. And typically, a length of icicle-type lighting terminates in an electrical plug 14 which can be connected with a power source such as an electrical outlet (or extension cord) for receiving electrical energy.

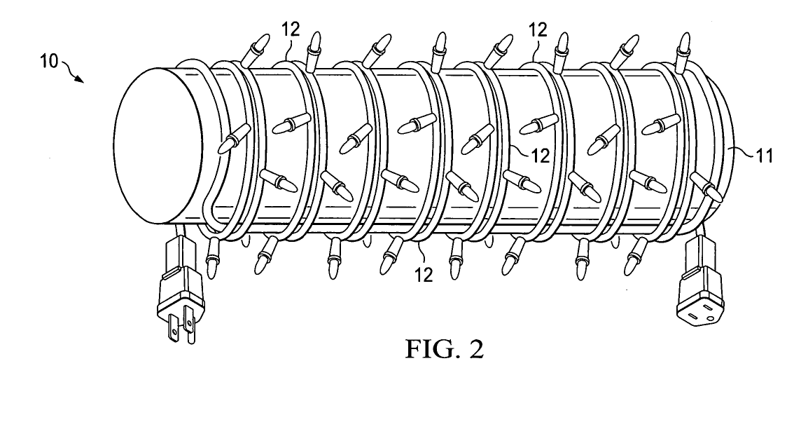

Referring next to FIG. 2 there is shown the embodiment of the storable holiday lighting system 10 in a stored or concealed position. System 10 again includes rod 11 and light strings 12. However, beginning from the position shown in FIG. 1, rod 11 has been rotated so as to cause light strings 12 to roll up around the circumference of rod 11. From their generally elongated, vertical arrangement shown in FIG. 1, the individual light strings 12 have now been placed in a generally circular or coil-like configuration around rod 11.

It will also be appreciated that the storable holiday lighting system can also be converted from the stored/concealed position of FIG. 2 back into the exposed/displayed position of FIG. 1. Rod 11 will be rotated so as to cause light strings 12 to unroll from rod 11. Gravity, pulling on the ends of light strings 12, will assist in allowing the individual strands of light strings 12 to unroll into the vertical configuration.

Referring generally to FIGS. 1 and 2, rod 11 is preferably of a generally cylindrical shape although other shapes are permissible. The diameter of rod 11 is a compromise between a desire for a small diameter rod so that it can be easily stored or concealed (as further explained herein) and the counterbalancing desire to provide a rod 11 of sufficiently larger diameter such that light strings 12 can readily wrap around rod 11 without the need for too high a number of rotations. Either small diameter or large diameter rods 11 will function, however.

The placement of cord 13 with respect to rod 11 can take a number of embodiments, any of which will function for the intended purpose. As illustrated in FIG. 1, a first embodiment is to position cord 13 such that it is generally positioned on the exterior or rod 11. One advantage of such a configuration is that the light string 12 and cord 13 assembly can be manufactured in a first manufacturing operation and then assembled with cord 13 in a separate manufacturing step. In this embodiment, cord 13 can be positioned proximate to rod 11 in a variety of different manners such as by stapling, gluing, and the like.

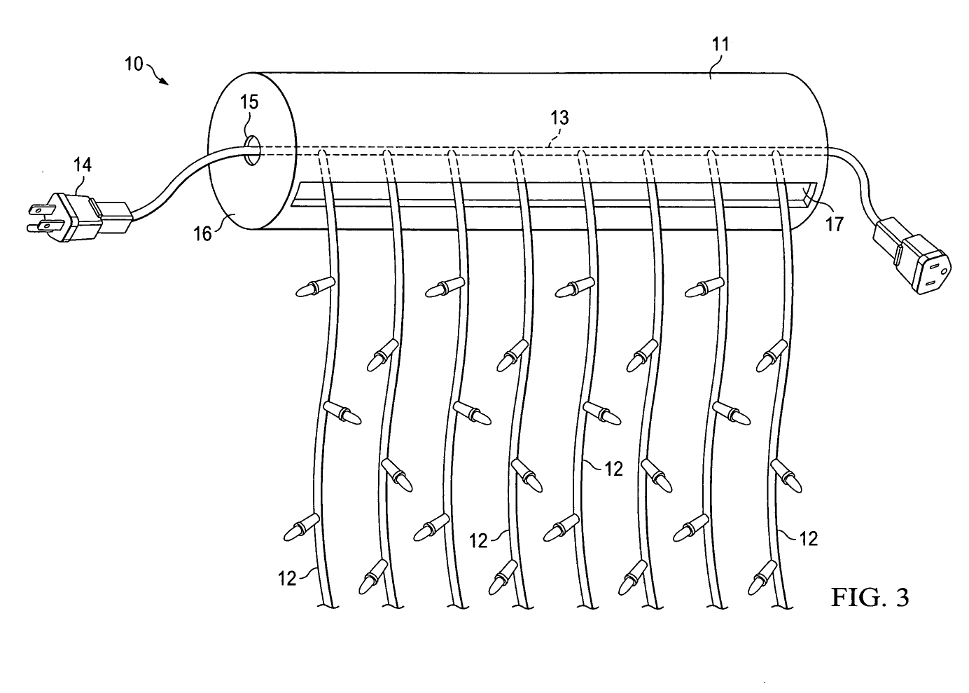

However, in an alternative embodiment, cord 13 can be configured so as to rest within a groove (not illustrated) provided in rod 11. Further, cord 13 can be configured so as to rest in the interior of rod 11, as shown in FIG. 3. An advantage of positioning cord 13 within the interior of rod 11 or within a groove is revealed in the following explanation. Rod 11 will receive a rotation in order to wrap light strings 12 around the outer circumference of rod 11. During the rotation procedure it may sometimes be desired not to have the plug end 14 of cord 13 foul or wrap around rod 11. Thus by positioning rod 11 within the groove or interior of rod 11 the rod 11 can be rotated without the fouling/wrapping of plug end 14 of cord 13.

A further embodiment of the invention would include individual light strings 12 that connect with rod 11. The connection between light strings 12 and rod 11 is configured such that the electrical power to light the lights on light strings 12 is provided through the light string 12 to rod 11 connection.

Referring next to FIG. 3 there is shown a further preferred embodiment of a storable holiday lighting system. The system of FIG. 3 includes rod 11, light strings 12, and cord 13 with a plug end 14. The cord 13 has been positioned within the interior of rod 11. Plug end 14 extends from the interior of rod 11 through an aperture 15 provided in a first end 16 of rod 11. Rod 11 further defines slit 17. Slit 17 generally extends along the length of rod 11 and is of a sufficient width so as to allow light strings 12 to extend through slit 17 to the exterior of rod 11. In operation the system of FIG. 3 provides the following advantages. When rod 11 is rotated the light strings 12 wrap or unwrap around the outer circumference 18 of rod 11. Plug end 14 of cord 13 is allowed to move freely within aperture 15 as rod 11 rotates. Thus plug end 14 does not excessively twist or foul during rotation. Further, if plug end 14 is connected with a further device such as another electric cord or extension cord (not shown) which imparts some resistance to rotation, plug end 14 will simply turn freely within aperture 15.

With respect to the embodiment described in FIG. 3 it should be appreciated that a plurality of individual holes or slits can be substituted for the one continuous slit 17 as illustrated. Additionally on the opposite end of rod 11 (not illustrated) there can be provided a further aperture 15 through which the receiving end (female end) of cord 13 can be positioned such that a female end or cord 13 extends from the interior of rod 11, through an aperture, and out to the exterior of rod 11. As an additional optional feature, plug end 14 can be pushed through aperture 14 when the lighting system is not in use so as to store the end of plug within the interior region of rod 11. Further, first end 16 of rod 11 can be configured so as to be removable. By removing the first end 16, a user can then retrieve plug end 14 from the interior region of rod 11, fish the plug end 14 through aperture 15 and reattach first end 16. Again, the opposite end of rod 11 can be configured in the same manner.

The above arrangement of the holiday lighting system is preferably modular such that a series of individual lighting units can be connected end to end. The units should be arranged so that a male plug connects to a female plug so as to provide power from one unit to the next. In this manner a series of individual rod assemblies can connected one to the next so as to extend lighting across a desired linear length.

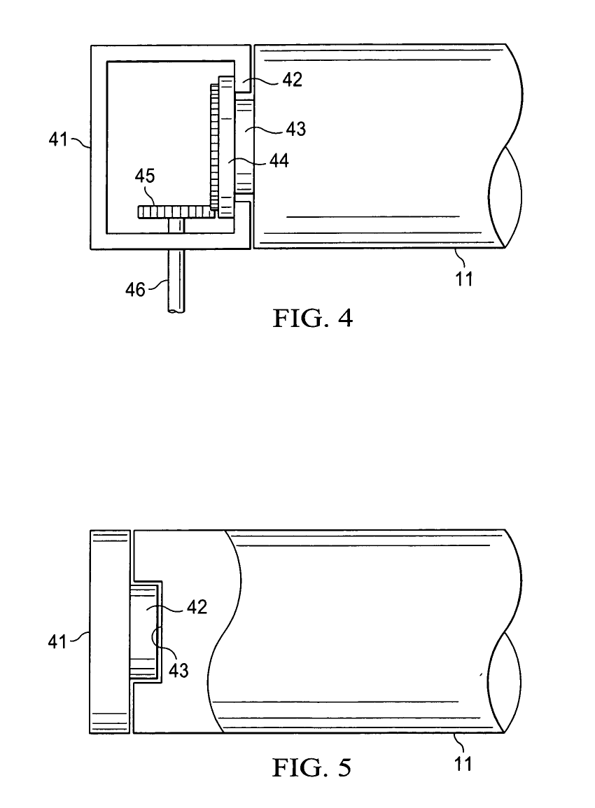

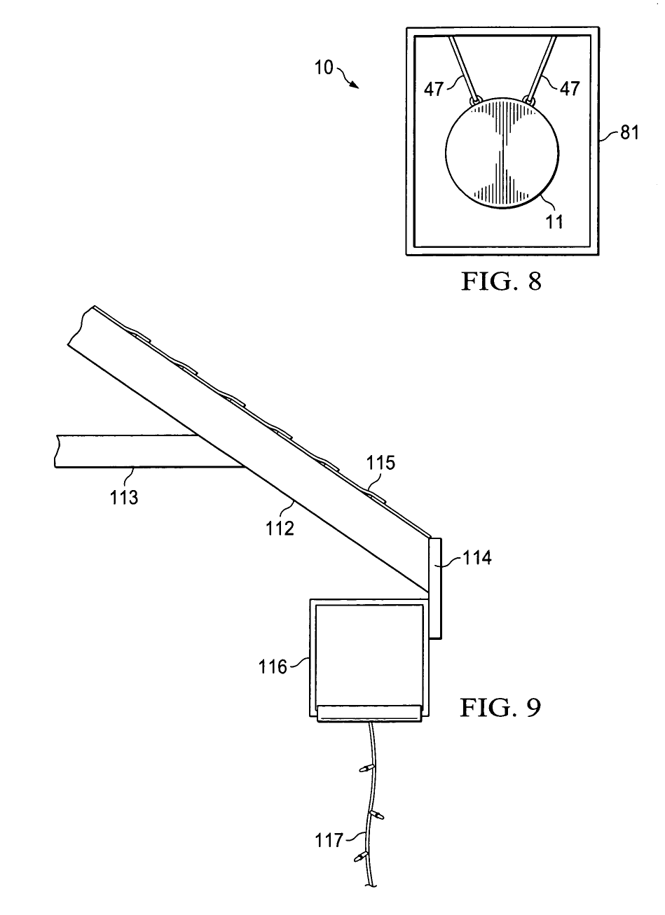

Referring next to FIG. 4 there is shown a further embodiment of the storable holiday lighting system. In this embodiment, the system includes an end cap 41 positioned at one or more ends of rod 11. Preferably end cap 41 is configured with bearings or races 42 which cooperate with reciprocally formed roller bearing 43 formed on the end of rod 11. This structure a thrust bearing structure so as to prevent lateral movement of rod 11, and the structure also provides bearing surfaces such that rod 11 can easily rotate while positioned in end cap 11. Preferably rod 11 is further provided with a ring gear 44. An engaging gear 45 can be positioned within end cap 41 such that rotation of the engaging gear 45 causes ring gear 44 to rotate, thereby imparting a rotation on rod 11. An activating member 46 can be connected to engaging gear 45. Activating member 46 can be a stick or rod of any desired length such that a user can rotate activating member 46 while the user is standing on the ground. The activating member 46 can translate rotational force from the user to the lighting system 10 positioned higher up than the user. Hangers 47 (shown in FIG. 8) can also be positioned on end cap 11 with which to suspend the lighting assembly from some structure such as, for example, a ceiling, roof, wall, or the like. End cap 41 can also be configured within aperture 15 so as to allow a cord 13 to pass therethrough as previously described.

It will be appreciated that variations to the general structure shown in FIG. 4 can be devised and yet still fall within the ambit of the invention. For example, a gearing force different from the cooperating ring gear 44 and engaging gear 45 can be devised including, for example, conical gears, screw type gears, ring and pinion gears, and the like. A series of gears can also be used to increase or decrease the rotational effect provided through an activating member. A driving force mechanism other than gearing can be employed. For example, rod 11 can be fitted with a pulley (not shown) and a belt can be positioned over pulley with which to drive a rotational force onto rod 11. Similarly a belt can impart a frictional force directly onto rod 11. Rod 11 could be turned manually. Also a mechanical means for rotating can be employed through a handle, lever, ratchet, and the like. Motorized force can also be used to rotate rod 11.

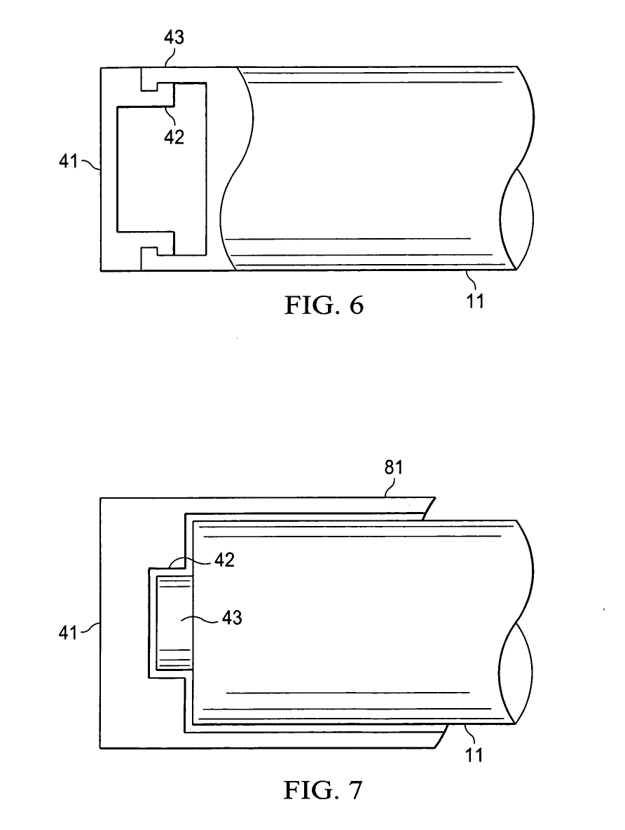

It will also be appreciated by those skilled in the art that structures other than that shown in FIG. 4 can be used to attach rod 11 to an end cap 41. A half bearing or saddle bearing can be used in which rod 11 is laid and rests on the saddle bearing. This is advantageous in being of a lower friction and also allowing for easy assembly. For further example FIG. 5 shows a thrust bearing configuration between end cap 41 and rod 11. FIG. 6 shows a further end cap 41 and rod 11 arrangement. FIG. 7 shows an additional configuration in which end cap 41 can provide the supportive and bearing function while also being part of a larger structure such as a cover.

One preferred means for rotating rod 11 is a mechanical structure in which a pulley is positioned on rod 11. Pulley is then actuated through application of some additional force such as belt or chain. Force can be applied to belt through other means. In a further preferred embodiment, means for rotating comprises a series of gears. A first gear is affixed to rod 11 so as to impart rotational force to rod 11. A second gear, or set of gears, receives motive force from an external source and is engaged with first gear so as transfer the force to first gear. In a preferred embodiment, an arrangement is configured such that a handle, driving rod, ratchet or the like is engaged with the second gear. In such a preferred embodiment a human operator can be positioned on the ground, well below rod 11 (wherein rod is suspended from a roof or other housing structure), and the operator can deploy the system from the concealed to the exposed position (and vice versa) by simply twisting a driving ratchet that extends from rod 11 to a position proximate the human operator. Preferably such a driving ratchet can be easily placed into and removed from the receiving driving means positioned proximate to rod 11. Finally, means for rotating 31 may also comprise an electrically driven motor connected to rod 11. Such a motor may be disposed within end cap 41. A motor may also be equipped with gearing so as to transfer force to rod 11.

Referring next to FIG. 8 there is shown a further embodiment of the storable holiday lighting system 10 configured in a holding/concealing structure. Before the embodiment is further described, a word as to the purpose of the embodiment will aid with understanding the embodiment of the illustration. As mentioned in the background of the invention, it would be desired to have a storable holiday lighting system. Such a storable lighting system would be semi-permanent in that a homeowner/user could install the lighting system one time one time on a structure such as a house. The lighting system could be displayed during the holiday season or during other festive occurrences. When not in use, the storable lighting system can be stored, while still attached to the house, in a manner that is substantially hidden from public view. Later, when it is desired to display the holiday lights again, the lighting system can be unstored such that the lighting system is placed again on public display. FIG. 8 illustrates a preferred embodiment for providing a storage function and concealing function.

Referring again to FIG. 8 there is provided the lighting system 10. Lighting system 10 is suspended from a structure through hangers 47. A cover 81 is placed around lighting system 10. Cover 81 substantially conceals lighting system 10 from view. Cover 81 can be attached to the house or other structure so as to be removeable. A snap on/snap off attachment is possible. Cover 81 need not attach to the house or structure and may attach to the lighting system 10 itself. Thus, during the holiday season, a user can remove cover 81 and display the string lights 12 in the manner as described herein. Then, at the conclusion of the holiday season, the user can reattach the cover 81 so as to substantially hide the lighting system 10 from public view. Cover 81 has been shown in substantially square or rectangular shape; however, other configurations are possible. Cover 81 may be curved, triangular, or any other shape. Curved shapes may be easier to manufacture as through plastic extrusion and may provide strength. However, rectilinear structures may more easily blend with the housing structure.

In a further embodiment, and as shown in FIG. 7, it is possible to provide a lighting system in which end cap 41 is an integral part of cover 81. In such an embodiment, cover 81 would also provide the function provided by end cap 41 and would thus be permanently attached to rod 11. It would be preferred to provide a slit or opening (not shown) in the bottom of the cover 81 of the embodiment in FIG. 7 through which light strings 12 can pass through. The slit or opening can be closed when not in use.

Rod 11 can be fashioned from any material. A wooden dowel or a plastic tube would serve. Generally, it would be preferred to fashion rod 11 from a light material such as an extruded plastic. A light material for rod 11 is preferred because, as explained further herein, rod 11 may be used in applications where rod 11 is suspended from a structure (such as a house) so as to serve as a base from which decorative lighting is displayed.

In a preferred embodiment, rod 11 is held or suspended in a desired position. Typically in order to allow the light strings 12 to deploy in the desired vertical configuration, the rod 11 will be positioned in a generally horizontal position. However, in gabled or peaked roofs it is acceptable to configure rod 11 so as to generally follow the roof line. It is also generally desired that rod 11 be suspended in a manner that allows for rod 11 to rotate.

Thus in a further embodiment, rod 11 is suspended on straps. The contact between straps 41 and rod 11 is of a low friction such that rod 11 can be made to rotate whilst resting on strap 41. In a further embodiment, a semicircular saddle bearing (not shown) can be positioned on rod 11 such that it allows for easy low friction movement of rod 11 positioned in a holding structure. Additionally, end piece can include a bearing or ratchet attached to a suspension piece so as to allow for easy rotation of rod 11.

More elaborate embodiments of the present invention can also be provided with motorized and automated features that allow for ease of operation. Electric motors, including geared electric motors can be provided proximate to rod 11 so as to provide rotational force. Sufficiently small electric motors can be positioned within an end cap 41 so as to be hidden from view. The control of the electric motor can be by switch, or preferably, by wireless control In this manner a user from a remote position can exert control of the motor and thus deploy or retract the lighting.

Referring now to FIG. 9, a portion of a house, a typical structure to which an embodiment of the storable holiday lighting system may be affixed, typically includes structural elements such as roof rafters 112, ceiling joists 113, and fascia board 114 as elements of construction. Tiles 115 or similar roofing material (shingles or roof covering) may further define the exterior roof of house 111. Light system enclosure 116 is affixed to fascia board 114. Light string 117 is positioned when deployed so as to extend from light system enclosure 116. Light system enclosure 116 preferably includes the cover 81, rod 11, and other light system elements.

Still referring to FIG. 9, it is noted that light system enclosure 116 is mounted to fascia board 114 such that cover board 116 can transition between an exposed and a concealed position. In the concealed position, light string 117 is generally concealed from public view, and in the exposed position light string 117 is generally open or exposed to public view. Public view within the purposes of this invention disclosure meaning a view that generally allows an observer from a typical observing point, such as the street or sidewalk in front of the house, to view the light string for its intended decorative and festive purpose.

In a preferred embodiment, light system enclosure 116 is mounted to fascia board 114 such that light system enclosure 116 so as not to be obviously visible from the typical vantage point of the street. The objective is that an observer, who would be positioned to view the ornamental lighting, such as an observer in the street outside the house, would not readily observe the enclosure 116 when it is in the placed in the exposed position. Thus, for example, the light system enclosure 116 can be positioned substantially to the rear of the fascia board 114 so as to be proximate to roof rafter 112. Light system enclosure 116 may be held in position proximate rafters 112 and fascia 114 by a conventional means such as snaps, hooks, or the like. In order to allow cover board 16 to be hidden in the exposed position, the exterior portion of enclosure 116 can be imprinted with a similar wood texture to that of fascia 114 and similarly painted. It is noted that in one embodiment, enclosure 116 extends below fascia 114. However, depending on the construction of the house, enclosure 116 can be entirely behind fascia 114. On other portions of the house, a lighting system such as enclosure 116 can be positioned directly on walls, support beams, frames, or any other portion of the structure. For example in backyard or side yard areas, it may not be as important to the homeowner to hide or conceal enclosure 116 from view. Thus while in the preferred embodiment described, enclosure 16 was described as affixed to fascia board 14. However, it should be appreciated that cover board 16 can alternatively be affixed to other elements of house 11. For example it may be affixed behind fascia board 14. It may be affixed to roof rafters 12.

As described herein, there is a method described for revealing and concealing festive holiday lighting. In on embodiment the method includes the steps of rotating a rod so as to enroll a length of light string and so as to expose the light string to a desired viewing area. An additional step includes further rolling, or, reverse rotating the rod so as to cause the light string to wrap up around the rod, thus removing the light string from view. Additional steps can include engaging gearing so as to cause the rod to rotate. Activating an electric motor so as to cause the rod to rotate; and transmitting wireless signals to a receive/controller connected to the electric motor so as to cause the rod to rotate.

As previously described it is preferred in one embodiment to create an individual light system segment in a modular fashion. In this manner additional units of the light system can be assembled, and thus, by assembling multiple units of light systems, a desired linear length can be decorated or covered with string lighting. Individual neighboring units can be connected electrically. Additionally individual neighboring units can be connected mechanically. In such a mechanical connection a rotation of a first light system unit causes that unit's rod to rotate, and in addition the sequential/neighboring unit's rod is mechanically connected and thus also rotates. The effect of such a modular connection of multiple individual light system units is that a user can cause an entire length of light string to deploy undeploy by simply rotating one individual unit. The rotation of the first unit is passed on to other connected units. Thus, a homeowner can raise/lower lights on one side of a house, for example, by engaging the manipulation rod of only one modular unit.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

What is claimed is:

1. A lighting system having a display configuration and a stored configuration, the lighting system comprising:
a rotating rod;
a plurality of light strings attached to the rod;
wherein the light strings are coiled around the rod in the stored configuration; and
wherein the light strings extend lengthwise from the rod in the display configuration.

2. The lighting system according to claim 1 further comprising an electrical connection line connecting at least two individual light strings wherein the electrical connection is attached to the rod.

3. The lighting system according to claim 1 further comprising a cover disposed substantially around the rod.

4. The system according to claim 1 wherein the rod defines a first end and a second end, and the system further comprising an end cap connected to at least one end of the rod, and wherein the rod is rotatably connected to the end cap.

5. The system according to claim 4 wherein the end cap defines an aperture and the system further comprising an electrical cord connected to at least one string, the electrical cord defining a plug end and wherein the plug end of the electrical cord is positioned so as extend through the aperture to an outer region of the rod.

6. The system according to claim 5 further comprising at least one hanger connected to the end cap.

7. A lighting system for providing lighting in a stored configuration and a displayed configuration, the lighting system comprising:
a rotating rod defining a first end and a second end, and further defining an interior region and an exterior region;
a plurality of light strings disposed so as extend from the rod in the display configuration and to coil around the exterior region of the rod in the stored configuration;
a cord defining a plug end and a receiving end, the cord connected to at least one of the light strings;
at least one end cap connected to the first end of rod such that rod can rotate with respect to end cap.

8. The lighting system according to claim 7 wherein the cord is substantially disposed within the interior region of the rod.

9. The lighting system according to claim 7 wherein the rod defines a rotating bearing surface and the end cap defines a cooperating receiving bearing surface.

10. The lighting system according to claim 7 wherein the end cap and the rod define mutual thrust bearing surfaces.

11. The lighting system according to claim 7 further comprising a means for rotating rod.

12. The lighting system according to claim 7 further comprising a gear connected to rod.

13. The lighting system according to claim 7 further comprising an actuating arm positioned within the end cap.

14. The lighting system according to claim 13 wherein the actuating arm further comprises a gear.

15. The lighting system according to claim 7 further comprising a cover.

16. The lighting system according to claim 15 wherein the end cap connects to the cover.

17. The lighting system according to claim 7 further comprising a motor connected to rod.

18. The lighting system according to claim 17 further comprising a wireless control unit for providing control signals to the motor.

19. A method for displaying lighting comprising the steps of:
providing a rod with a light string wrapped around the rod;
rotating the rod so as to unroll the light string from around the rod thereby displaying the light string.

20. The method according to claim 20 further comprising the step of rotating the rod so as to roll the light string around the rod thereby concealing the light string.
